(19) United States
(12) Patent Application Publication
(10) Pub. No.: US 2005/0014462 A1
(43) Pub. Date: Jan. 20, 2005

(54) Device for dispensing disc-shaped objects, such as coins

(76) Inventors: Leonardus Albertus Patrick Suverein, Kalmthout (NL); Cornelis Martinus Suverein, Rotterdam (NL); Edwin Andre Roodenburg, Krimpen A/D Ijssel (NL)

Correspondence Address: HOFFMANN & BARON, LLP, 6900 JERICHO TURNPIKE, SYOSSET, NY, 11791, US

(21) Appl. No.: 10/496,613

(22) PCT Filed: Dec. 5, 2002
(86) PCT No.: PCT/NL02/00794

(30) Foreign Application Priority Data
Dec. 6, 2001 (NL) 1019509

(51) Int. Cl. G07D 1/00

(52) U.S. Cl. 453/29

(57) ABSTRACT

A device for transferring a flow of disc-shaped objects, such as coins, from a reservoir to a delivery location at a higher level. This device is provided with a coin guiding passage that has its bottom positioned in an inclined plane, said passage being connected to the reservoir through a passage portion that has its longitudinal axis directed substantially horizontally and merging into a portion that rises towards said delivery location through a curved section of substantially 90°. To avoid hold up of the coin travel in the coin guiding passage, a number of control arms is provided within said curved section, said arms being adapted to rotate in the travel direction about an axis located adjacent the inside bend side wall of the curved section and extend substantially radially outwardly from said axis; in operation said arms extend between the successive coins in the coin guiding passage of the curved section, due to which the coins will “round the curve” with more certainty.

The invention relates to a device as defined in the first part of claim 1.

A device of this type is well-known. Typical examples of it are disclosed e.g. in EP document 0311320 and U.S. Pat. No. 5,181,881. Typically in this type of device the coins to be dispensed are pushed by and off the rotating bottom plate—at the uppermost location of the latter—substantially horizontally and tangentially relative to said location so as to first form a substantially straight flow of coins in edge-to-edge contact with one another prior to causing the coins to move through a curved guiding passage section into and through the rising guiding passage of the coin raising conveyor. The transportation of the coins from the coin reservoir to the delivery location is exclusively effected by the pushing force that is exerted by the rotating bottom plate. In this respect a device of this type distinguishing from a coin dispensing device of a second type, wherein a separate transporting means is needed and is provided adjacent the uppermost location of an inclined, rotating bottom plate to “scoop” the coins arriving at said location off the rotating bottom plate and cause these coins to move directly upwardly towards and through the rising guiding passage of a coin raising conveyor. Examples of this second type of coin dispensing device are disclosed e.g. in EP documents 0204405 and 0612041. Turning now to the well-known device of the first type above referred to, EP document 0311320 describes the risk for a deformed (bent) coin to become jammed or blocked within the curved section of the through-shaped coin guiding passage under the influence of the pressure or back pressure that is applied to it by a coin positioned downstream or upstream of it in case the through-shaped coin guiding passage is covered—at the site of the curved section—from both sides by an upper wall (portion), as shown in FIG. 9 of the document. The deformed coin might then become jammed with an edge portion between the passage bottom and an upper wall portion. Obviously one starts from the assumption that the internal distance between the passage bottom and the upper wall (portions) is relatively exactly adapted to a predetermined coin thickness.

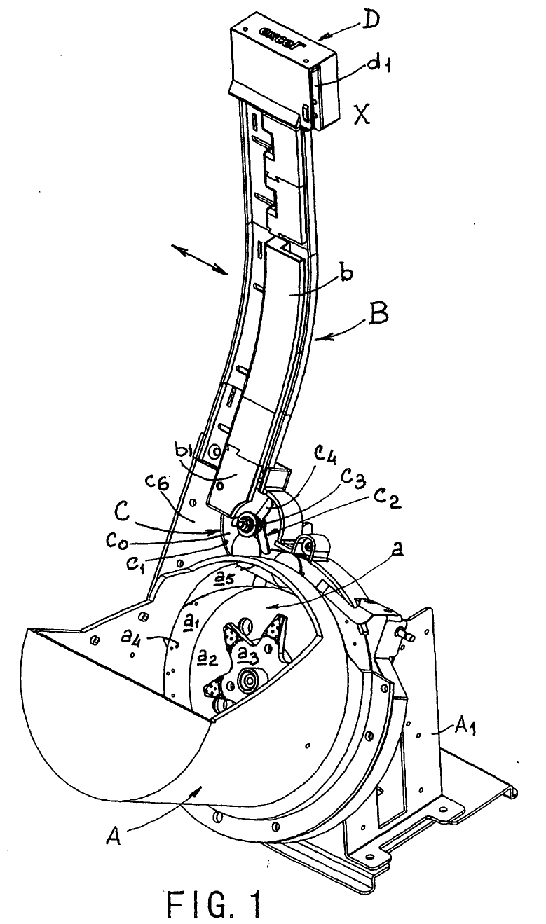

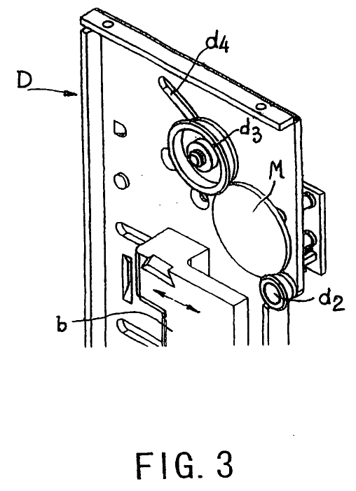

In the coin dispensing device proposed in the above document the means for eliminating jamming or blocking of coins within the curved section consists in that the coin guiding passage is completely open (i.e. not covered by an upper wall (portion)) at least at the outside bend of the curved section and in that the passage side wall at the outside bend of the coin guiding passage is taking an outwardly inclined position relative to the passage bottom, whereas the coin guiding passage at the inside bend is either (i.e. in a first embodiment according to FIGS. 1 and 3 of the document) partially covered “in the normal way” by a rigid upper wall portion, or (in a second embodiment according to FIG. 8 of the document) also completely open at the top, while the side wall of the coin guiding passage located at the inside bend is capable of yielding, against spring action, a little into the upstream or downstream direction about its centre of curvature. In the second case the height of the side wall at the outside bend of the coin guiding passage would be preferably smaller than the thickness of a coin.

It is said to apply for both of the embodiments, that a deformed coin that would “normally” get jammed is now simply thrown out by an adjacent coin at the outside bend of the coin guiding passage.

A disadvantage of the devices above referred to is to be seen in that the chance that a “normal” coin is unintentionally thrown out increases according to a deformed coin being expelled with more certainty. For also in case of handling only clean coins an irregular play of forces, characterized by pressure and back pressure forces of varying directions and magnitudes, will occur in the curved section of the coin guiding passage. The result of this is a shock-wise transportation of the coins through the curved section, whereby particularly in the upper part of the curved section successive coins will ultimately move apart and bump up against one another. Under these conditions even a clean coin may easily get released from the passage bottom and there will be a real chance—in case of sufficient freedom of swerving in a direction perpendicular to the passage bottom such as with the devices above described—that successive coins will get into mutually overlapping positions and thus cause an operational failure.

In the device according to U.S. Pat. No. 5,181,881 the coin guiding passage in the curved section is partially covered by a flexible upper wall portion that extends from the inside bend partially across the guiding passage. This prevents the guiding passage in the curved section from being blocked by a curved, because, if a deformed coin enters into contact with the flexible upper wall portion and there is chance for the deformed coin to get in overlapping relationship with a leading coin the said flexible upper wall portion may resiliently deform and give way for the deformed coin to be pushed out. However, as remarked herein before in connection with EP document 0311320 the structure proposed in U.S. Pat. No. 5,181,881 does not exclude that a “normal” coin is falling into an overlapping relationship with a leading or trailing coin and will thus be pushed out unintentionally, unless the flexible wall portion is kept under a certain pretension so that the coins are kept lying flatly on the passage bottom. A sufficiently pre-tensioned upper wall portion, however, would introduce frictional resistance to the coin travel and put additional load in the drive motor of the rotating bottom plate.

Therefore the present invention aims at providing an improved coin dispensing device of the type above referred to and more particularly an improved coin movement through the curved section of the coin guiding passage, so as to increase the reliability in operation of the device, without coins being thrown out unnecessarily.

According to the invention this aim is achieved by the feature that is defined in the second part of claim 1.

Due to the control arms which—in operation—extend between the coins in the coin guiding passage of the curved section a more uniform travel of the coins through the curved section is obtained and the tendency of individual coins to jump up from the bottom is reduced to a minimum, while the coin guiding passage in the curved section may be left open at the top.

Moreover hold up caused by deformed (bent) coins or differences in thickness between clean coins is excluded.

In a preferred embodiment the control arms constitute the teeth or blades of a separate gear or blade wheel respectively, that is adapted to be driven in synchronism with the rotary bottom plate of the coin storing reservoir. With such a gear or blade wheel, that is driven in synchronism with the rotary bottom plate of the coin storing reservoir the rotating arms or blades cause the coins in the curved section to “round the curve” in an uniform flow, thereby putting a minimum load on the drive motor of the system.

It is to be noted that the use of a blade wheel that is driven in synchronism with the rotary bottom plate of a coin storing reservoir is known per se with a coin dispensing device of the second type referred to herein before. With this type of coin dispensing device the blade wheel extends with its blades into the path of the rotary bottom to divert coins from said path and carry these coins directly to a location on a higher level. In this case there is no guiding of coins through a curved section of a raising conveyor.

With the device of the present invention the raising part of the coin guiding passage following the curved section may be advantageously covered from one side by a covering strip that has its passage facing side planted with bristles such as described in EP document 0 950 989.

In a similar way, according to a further feature of the present invention, the downstream part of the coin guiding passage in the curved section which is not covered by the control arms, is covered by a covering wall portion that has its passage bottom facing side planted with bristles.

The invention will be hereinafter further explained by way of example with reference to the drawing.

FIG. 1 is a perspective view of the complete device according to the invention, adapted for use in a game machine;

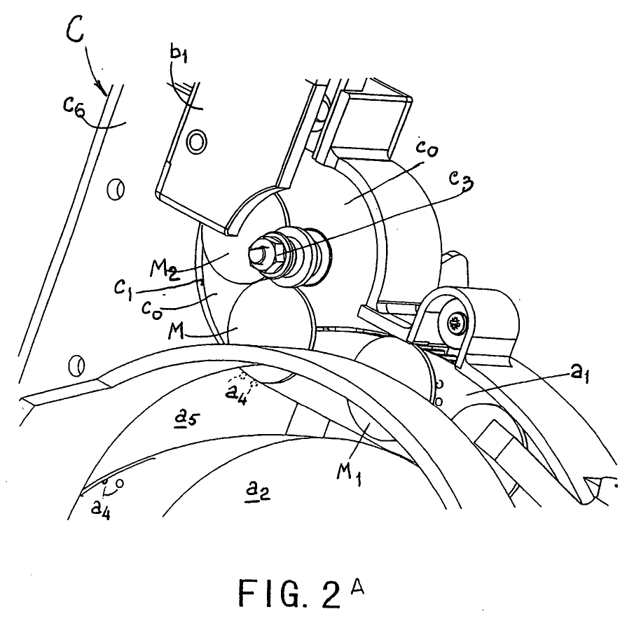

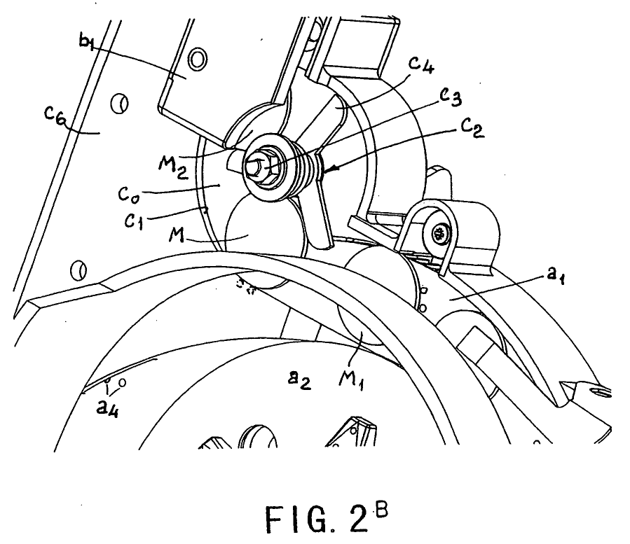

FIG. 2A is a perspective view on a larger scale of the curved section between the coin raising conveyor (escalator) and the coin reservoir (hopper), from which the blade wheel of the present invention has been removed;

FIG. 2B is a view as represented in FIG. 2A, but now with the blade wheel of the invention mounted in place; and

FIG. 3 is a perspective view of a detail of the upper end section of the coin raising conveyor.

The device shown in FIG. 1 is a combination of a coin supply or storing reservoir A and a coin raising conveyor B with a transitional curved section C there between.

The coin reservoir A—also called “hopper”—is of a well-known type; it is mounted on a base Al and has an inclined bottom plate a, which—as seen in the drawing—is adapted to be driven counter clock-wise by means of a drive motor (not shown). The bottom plate a has an annular outer portion a1 and a central disc-shaped portion a2 of a smaller diameter, the latter is taking a position that is elevated above the plane of the annular bottom plate portion a1 through an amount that is in the order of magnitude of the thickness of the coins to be handled. Furthermore the central bottom plate portion a2 carries a star-shaped coin mover a3 and the outer annular bottom plate portion a1 is provided with circumferencially spaced control pins a4.

In operation, with the reservoir A (partially) filled with coins and the bottom plate a rotating counter clock-wise (see FIG. 1), there is formed in the lower area of the reservoir, with the assistance of the coin mover a3, a ring of coins, which are caught between the control pins a4 and are lying flat on the outer annular bottom plate portion a1. The coins from this ring of coins are taken along and moved upwardly by the control pins a4 on the right side of the reservoir into the right upper quadrant, where the coins are supported with their circumferencial edges on the circumferencial edge of the central bottom plate portion a2 functioning as a support ledge. In the upper quadrant to the left in FIG. 1 there is provided a delivery knife a5. The coins arriving at the highest location on the outer annular bottom plate portion al are “stripped” by the knife a5 off the support ledge (circumferencial edge) of the central bottom plate portion a2 and then guided over the (at least) substantially horizontally extending upper edge of this knife so as to form a (substantially) horizontal coin flow which is tangentially directed relative to the support ledge of the central bottom plate portion a2. This coin flow is discharged from the coin reservoir A through a coin outlet opening under the influence of the pressure forces which are applied by the control pins a4 to the individual coins in the coin flow. The coin outlet opening is formed by a local interruption of the reservoir wall. The coin flow leaving the reservoir A is, at first, turned upwardly through an angle of about 90° within the plane of the annular bottom plate portion al before being pushed further upwardly through the coin raising conveyor B towards the delivery location X.

Turning the coin flow from the coin reservoir A upwardly through an angle of 90° is taking place within the curved section C, which may be further described below. At first reference is made to FIG. 2A, in which a curved section is shown which is completely open because the blade wheel of the invention to be described yet has been removed therefrom. FIG. 2A represents the moment at which the coin M has almost completely left the coin reservoir A and is about to loose its contact with the control pin a4 due to which it is no longer pushed up individually and therefore is about to fall back towards the next coin M1. It will be clear that this tendency to fall back is increased by the weight of the coin M2, that has become released from its control pin in an earlier stage and has almost “rounded the curve” while its circumferencial edge has become into contact with the circumferencial edge of the coin M. The result is, that the coins are raised shock-wise through the curved section C, so that there is the chance, that a coin looses its contact with its supporting base, as explained already herein above. This risk of “tipping up” of a coin in the curved section C will be greater according to the coin diameter being larger and the velocity at which the coins are discharged by the control pins a4 from the coin reservoir A being higher.

The curved section C has a bottom c with an outside bend wall C1 extending therefrom upwardly, which guides the coins towards the raising conveyor B (FIG. 1). To avoid the above described tendency of the coins to “tip up” there are provided, according to the invention (see FIG. 2B) a number of control arms or blades c4 within the curved section C, which are making part of a blade wheel that is mounted for rotation about an axis c3. The control arms c4 of the blade wheel c2 lie substantially onto the bottom c0 and their height corresponds with the (averaged) thickness of the coins to be handled.

The inside bend side wall of the coins guiding passage in the curved section C is in fact constituted by the axis c3 or the hub respectively of the blade wheel c2. The blade wheel c2 is mounted to be driven in synchronism with the bottom plate a. In FIG. 2B this is demonstrated by representing part of the bottom C as a gear c5, which is driven—in a suitable transmission ratio—by the outer annular portion al of the bottom plate a of the coin reservoir A, said portion being therefore provided with gear teeth at its outer circumference.

Due to using the blade wheel c2 each time a coin, which is about to loose its contact with the respective control pin(s) c4, is prevented by the next control arm (or blade) from falling back and is thus taken along in the travel direction. At the same time the coin M2 (compare FIG. 2A), which in an earlier phase has almost completely “rounded the curve”, is prevented by the adjacent control arm c4 (or blade) downstream of it from falling back and is thus pushed into the lower portion of the guiding passage of the raising conveyor B.

In each of the cases represented in FIGS. 2A and 2B the outside bend wall C1 is obtained by putting on a flat base—of which the curved section bottom C is making part—a plate section c6 that in the example shown is integrally formed with the delivery knife a5.

Preferably the raising conveyor B is of the type described in EP document 0 950 989 and provided with a coin guiding passage with a bottom and side walls extending therefrom, which passage is covered by a covering strip that is planted with bristles.

In FIG. 1 a covering strip b is shown, which is composed of a number of sections. Of course the bristles of the strip b, which are directed towards the passage bottom of the raising conveyor B, cannot be seen in the drawing. The covering strip is mounted for adjustment in the transversely (see the arrow direction) and comprises the passage side wall that extends from the passage bottom on the left side. The covering strip b is adjusted according to the diameter of the coins to be handled and its adjustable passage side wall connects to the outside bend wall cl of the curved section C. It is of particular importance that the lower section b1 of the covering strip b extends as far as over the upper portion of the coin guiding passage in the curved section C which is not covered by the control arms c4 of the blade wheel. As a result bristles (preferably directed obliquely into the travel direction) are also operative in that passage portion and will prevent a coin that has been pushed into that passage portion from falling back after it has been disengaged from the respective control arm to allow the coin to get in edge to edge contact with a next coin.

By means of the described combination of the coin reservoir A, the raising conveyor B and the curved section C there between the coin supply from the coin reservoir A is transferred to a coin flow that uniformly moves via the curved section C and the raising conveyor B to the delivery location X. Variations in thickness, if any, such as caused by deformation, do not affect the uniform character of the coin flow. It is important, of course, that the uniform character of the coin flow continues at the upper end of the raising conveyor B, where an end section D is provided that has a laterally opening dispensing slot d1. To this end a pair of ejecting rollers d2, d3 is provided in the end section D, of which one roller d2 has its axis fixed in place and the second roller d3 is mounted for a swerving movement, against spring action, in a direction towards the dispensing slot d4. Due to the tapered shape of the rollers d2 and d3 the coins are kept in contact with the bottom in the end section D, which prevents hold up from occurring in the coin delivery.

1. A device for dispensing disc-shaped objects, such as coins, comprising
a coin storage reservoir with an inclined rotary bottom plate and provided with a coin outlet opening, which is directed substantially tangentially relative to the top location of the bottom plate, said bottom plate being adapted to arrange the coins in the reservoir into a continuous flow of successive, flat lying coins and to push the coins from said flow, starting from the top location of the rotary bottom plate, along a substantially straight path in a substantially horizontal direction one by one towards and through the coin outlet opening, and
a conveyor for raising the coins from the level of the outlet opening of the coin storing reservoir to a deliver location at a higher level, said conveyor comprising a trough-shaped coin guiding passage that is substantially formed by a bottom and two opposite side walls, said passage having at its lower end and curved section that is connected with said outlet opening, said curved section being adapted to receive the flow of coins discharged through the outlet opening of said reservoir in flat on the passage bottom lying positions and to bend the received flow of coins substantially through 90° towards the raising part of the coin guiding passage comprising a number of control arms which are adapted to rotate about an axis located adjacent the inside bend side wall of the curved section and extend substantially radially outwardly from said axis, said arms being capable of extending—in operation—between the successive coins in the coin guiding passage of the curved section, whereby the coin guiding passage side wall at the inside bend is recessed through a distance corresponding with the diameter of the path described by the control arms.

2. A device according to claim 1, wherein the control arms constitute the teeth or blades of a separate gear or blade wheel respectively, that is adapted to be driven in synchronism with the rotary bottom plate of the coin storing reservoir.

3. A device according to claim 1, wherein the control arms constitute the teeth or blades of a separate gear or blade wheel respectively, that is adapted to be driven in synchronism with the rotary bottom plate of the coin storing reservoir, and the forwardly directing edges of the control arms are trailingly shaped as seen radially outwardly.

4. A device according to claim 1, wherein the downstream portion of the coin guiding passage in the curved section, which is not covered by the control arms is covered by means of a covering wall portion that has its passage bottom facing side plated with bristles.
